(19) United States
(12) Patent Application Publication
(10) Pub. No.: US 2014/0042675 A1
(43) Pub. Date: Feb. 13, 2014

(54) METHOD FOR MANUFACTURING AN ALUMINUM NITRIDE PARTICLE AND APPLICATION THEREOF

(71) Applicant: BUREAU OF ENERGY MINISTRY OF ECONOMI, Taipei City (TW)

(72) Inventors: Shyan-Lung CHUNG, Taipei City (TW); Ruei-Pu TIAN, Taipei City (TW); Shu-Chi HUANG, Taipei City (TW); Chun-Hung LAI, Taipei City (TW)

(73) Assignee: BUREAU OF ENERGY MINISTRY OF ECONOMIC AFFAIRS, Taipei City (TW)

(21) Appl. No.: 13/683,561

(22) Filed: Nov. 21, 2012

(30) Foreign Application Priority Data
Aug. 7, 2012 (TW) 101128488

(51) Int. Cl. C01B 21/072

(52) U.S. Cl. CPC C01B 21/0728
USPC 264/670; 264/117

(57) ABSTRACT

A method for manufacturing an aluminum nitride particle includes the steps of wet-milling an aluminum nitride material to form a solution containing aluminum nitride powders; blending a binding agent and a dispersing agent with the solution to gain a slurry; and granulating the slurry to obtain the aluminum nitride particle.

### CROSS REFERENCE

The application claims priority from Taiwan Patent Application NO. 101128488, filed on Aug. 7, 2012, the content thereof is incorporated by reference herein.

### FIELD OF THE INVENTION

The invention relates to a production method of an aluminum nitride particle, and more particularly to, an improved method for manufacturing an aluminum nitride particle and its application.

### BACKGROUND OF THE INVENTION

Aluminum nitride has properties including low thermal expansion coefficient, high electric insulation, well mechanical strength, and low dielectric constant, and thus, it has been employed as the material for making an electrical substrate.

Currently, an electrical substrate is made by placing a reaction material for the substrate subject to a shaping process, and then a sintering process is applied to the reaction material. Initially, the shaping process is mainly dry shape, but the quality of the electrical substrate made by this technique is low due to insufficient particle flow, low and inconsistent density. In view of those problems, spray granulation technique has been adopted to replace the dry shape technique. In spray granulation technique, a material is mixed with a solvent, and then the combination is wet-milled. Thereafter, the resulted solution is dried, and a powder having a proportional particle size is given. Next, the powder is added into another solvent containing a binding agent and a dispersing agent, and well mixed to form slurry. Considering the subsequent use of the particle, a sintering agent may be added to the slurry mixture when the particle is, for example, sintered to form the electrical substrate. Finally, the slurry is granulated in a granulating machine to form the particle. The detailed description of granulating is seen in US Patent Application No. 20090283933 and U.S. Pat. No. 7,605,102. The particle can be used in any appropriate application apart from the use of forming the electrical substrate. When the particle is sintered to form the electrical substrate, the mold is filled with the particle such that those problems of dry shaping technique are overcome and the quality of an electrical substrate is enhanced.

Although the quality of a particle and its subsequent product made by spray granulation technique is greatly enhanced when compared with the conventional product, this technique is time-consuming and has high production cost. As such, under the premise that the quality of the particle and its subsequent product is to be maintained, there is need to improve the current method for making the particle using spray granulation technique.

### SUMMARY OF THE INVENTION

One objective of the invention is to provide an improved method for manufacturing an aluminum nitride particle, which simplifies the manufacture process and reduces cost.

According to the foregoing and/or other objective, a method for manufacturing an aluminum nitride particle is disclosed. The method includes the following steps: wet-milling an aluminum nitride material to form a solution containing aluminum nitride powders; mixing a binding agent and a dispersing agent with the solution to gain slurry; and granulating the slurry to obtain the aluminum nitride particle.

Another objective of the invention is to provide an improved method for manufacturing an aluminum nitride substrate, and the method simplifies production process and production cost.

According to the foregoing and/or other objective, a method for manufacturing an aluminum nitride substrate is disclosed. The method includes the following steps: wet-milling an aluminum nitride material to form a solution containing aluminum nitride powders; mixing a binding agent, a dispersing agent, and a sintering agent with the solution to gain slurry; granulating the slurry to obtain an aluminum nitride particle; and sintering the aluminum nitride particle to form into a material for forming the aluminum nitride substrate.

In both of the disclosed methods, the binding agent, the dispersing agent, and/or the sintering agent are mixed with the solution. In such a way, production process for making the aluminum nitride particle and the aluminum nitride substrate is shortened, and production cost for making the aluminum nitride particle and the aluminum nitride substrate is lowered. Additionally, the product quality made by both of the disclosed methods is still maintained when compared with that of the products made by the prior methods.

### BRIEF DESCRIPTION OF THE DRAWINGS

FIG. 1 is an electron-microscopic picture showing an aluminum nitride particle of Example 1.

### DETAILED DESCRIPTION OF THE INVENTION

The detailed description and preferred embodiment of the invention will be set forth in the following content, and provided for people skilled in the art so as to understand the characteristic of the invention.

In one embodiment, a method for manufacturing an aluminum nitride particle is disclosed as below.

Firstly, an aluminum nitride material is wet-milled to form a solution containing aluminum nitride powders. In detail, the aluminum nitride material is mixed with a solvent, and then the aluminum nitride material is milled in any commercially purchased wet-milling machine to form the solution. The solvent may be an organic solvent, and an example of the solvent is, but not limited to, methyl ethyl ketone, ethyl alcohol, isopropyl alcohol, toluene, diethyl ether, trichloro ethylene, methanol, or any combinations thereof.

It is noted that according to the subsequent use of the aluminum nitride particle, the aluminum nitride powders may have different particle sizes. In one preferable embodiment, the aluminum nitride powders are in a particle size of 2-12 μm.

Secondly, a binding agent and a dispersing agent are mixed with the solution to gain slurry. The term “binding agent” used in this content means a material which allows the aluminum nitride powders to mix with each other. In one preferred embodiment, the binding agent may be vinyl resin, cellulose resin, acrylic resin, or any combinations thereof. An example of the vinyl resin is, but not limited to, polyvinyl alcohol, polyvinyl butyral, polyvinyl chloride, or combinations thereof. An example of the cellulose resin is, but not limited to, methyl cellulose, ethyl cellulose, hydroxyethyl cellulose, or any combinations thereof. An example of the acrylic resin is, but not limited to, polyacrylate ester, polymethyl methacrylate, or any combinations thereof. The term “dispersing agent” used in this content means a material which allows solid materials in the slurry to uniformly disperse in the slurry. In one preferred embodiment, the dispersing agent may be ethylene glycol, glycerol, triethyl phosphate, or any combinations thereof.

It is noted that solid content of the slurry should be in a proper proportion and not be too high or too low. When the solid content of the slurry is too high or too low, the subsequent aluminum nitride particle may be formed difficultly. In one preferable embodiment, the solid content of the slurry is 50-60%.

Finally, the slurry is granulated to obtain the aluminum nitride particle. In detail, the slurry is disposed in a commercially purchased granulating machine, and then the slurry is agglutinated with appropriate reaction parameters to form the aluminum nitride particle.

In another embodiment, a method for manufacturing an aluminum nitride substrate is disclosed as below.

Firstly, an aluminum nitride material is wet-milled to form a solution containing aluminum nitride powders. In detail, this step is similar to the aluminum nitride material wet-milling step of the foregoing method for manufacturing an aluminum nitride particle, and therefore, there is no need for further description.

Secondly, a binding agent, a dispersing agent, and a sintering agent are mixed with the solution to gain a slurry. This step is partially similar to the binding agent and dispersing agent mixing step of the foregoing method for manufacturing an aluminum nitride particle, and therefore, there is no need for further description. What needs to be emphasized is that, the term “sintering agent” used in the content means a material which helps the formation of the aluminum nitride substrate. The sintering agent may be a rare earth compound. An example of the rare earth compound is, but not limited to, nitride, oxide, fluoride, stearic acid, or any combinations thereof. In one preferred embodiment, the sintering agent is zirconium dioxide, yttrium oxide, lanthanum oxide, scandium oxide, or any combinations thereof.

Thirdly, the slurry is granulated to obtain an aluminum nitride particle. In detail, this step is similar to the slurry granulating step of the foregoing method for manufacturing an aluminum nitride particle, and therefore, there is no need for further description.

Finally, the aluminum nitride particle is sintered to form the aluminum nitride substrate. In detail, the aluminum nitride particle is disposed in an atmosphere of non-oxidative gas and heated at a temperature of more than 1500° C.

The following examples are provided for further description of the invention.

### EXAMPLE 1

An aluminum nitride material (1.2 kg) having a particle size of 270 meshes is added in ethanol (0.8 kg), and the aluminum nitride material is wet-milled at 350 rpm for one hour to form aluminum nitride powders having a particle size of 2-3 μm. After which, polyvinyl butyral (63.6 g, MW: 40,000-70,000), triethyl phosphate (8.4 g), and yttrium oxide (60 g) are added in the resulted solution to form a slurry having a solid content of 62.4%. Then, the slurry is kept on blending for 22 hr.

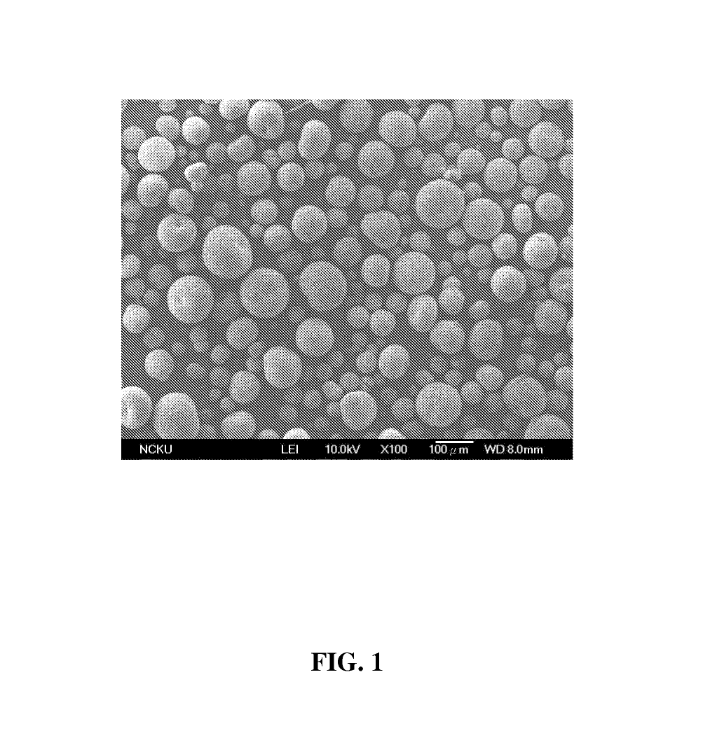

The slurry is placed in a granulating machine (Model: CL-8, purchased from Ohkawara Kakohki Co., Ltd.). The slurry is granulated with reaction parameters including a sprayer rotational speed of 10,000 rpm, an inlet temperature of 110° C., an outlet temperature of 85° C., and a feeding speed of 4 kg/hr, and then, the slurry is agglutinated to form an aluminum nitride particle (see FIG. 1). Finally, the nature of this aluminum nitride particle is determined, and a D50 particle size of 110.7 μm is given.

### EXAMPLE 2

An aluminum nitride material (1.2 kg) having a particle size of 270 meshes is added in ethanol (0.8 kg), and the aluminum nitride material is wet-milled at 350 rpm for one hour to form aluminum nitride powders having a particle size of 2-3 μm. After which, polyvinyl butyral (63.6 g, MW: 20,000-30,000), triethyl phosphate (8.4 g), and yttrium oxide (60 g) are added in the resulted solution to form a slurry having a solid content of 62.4%. Then, the slurry is kept on blending for 22 hr.

The slurry is placed in a granulating machine (Model: CL-8, purchased from Ohkawara Kakohki Co., Ltd.). The slurry is granulated with reaction parameters including a sprayer rotational speed of 10,000 rpm, an inlet temperature of 110° C., an outlet temperature of 80° C., and a feeding speed of 4 kg/hr, and then, the slurry is agglutinated to form an aluminum nitride particle. Finally, the nature of the aluminum nitride particle is determined, and a D50 particle size of 85 μm is given.

### EXAMPLE 3

An aluminum nitride material (1.2 kg) having a particle size of 270 meshes is added in ethanol (0.85 kg), and the aluminum nitride material is wet-milled at 350 rpm for one hour to form aluminum nitride powders having a particle size of 2-3 μm. After the foregoing step, polyvinyl butyral (36 g, MW: 20,000-30,000), triethyl phosphate (4.8 g), and yttrium oxide (60 g) are added in the resulted solution to form a slurry having a solid content of 60.5%. Then, the slurry is kept on blending for 22 hr.

The slurry is placed in a granulating machine (Model: CL-8, purchased from Ohkawara Kakohki Co., Ltd.). The slurry is granulated with reaction parameters including a sprayer rotational speed of 10,000 rpm, an inlet temperature of 110° C., an outlet temperature of 80° C., and a feeding speed of 4 kg/hr, and then, the slurry is agglutinated to form an aluminum nitride particle. Finally, the nature of the aluminum nitride particle is determined, and a D50 particle size of 69.9 μm is given.

### EXAMPLE 4

An aluminum nitride material (1.2 kg) having a particle size of 270 meshes is added in ethanol (0.85 kg), and the aluminum nitride material is wet-milled at 350 rpm for one hour to form aluminum nitride powders having a particle size of 2-3 μm. After the foregoing step, polyvinyl butyral (36 g, MW: 20,000-30,000), triethyl phosphate (4.8 g), and yttrium oxide (60 g) are added in the resulted solution to form a slurry having a solid content of 60.5%. Then, the slurry is kept on blending for 22 hr.

The slurry is placed in a granulating machine (Model: CL-8, purchased from Ohkawara Kakohki Co., Ltd.). The slurry is granulated with reaction parameters including a sprayer rotational speed of 7,000 rpm, an inlet temperature of 110° C., an outlet temperature of 80° C., and a feeding speed of 4 kg/hr, and then, the slurry is agglutinated to form an aluminum nitride particle. Finally, the nature of the aluminum nitride particle is determined, and a D50 particle size of 77.1 μm is given.

### EXAMPLE 5

An aluminum nitride material (1.2 kg) having a particle size of 270 meshes is added in ethanol (0.85 kg), and the aluminum nitride material is wet-milled at 350 rpm for one hour to form aluminum nitride powders having a particle size of 2-3 μm. Then, polyvinyl butyral (36 g, MW: 20,000-30,000), triethyl phosphate (4.8 g), and yttrium oxide (60 g) are added in the resulted solution to form a slurry having a solid content of 60.5%. Then, the slurry is kept on blending for 22 hr.

The slurry is placed in a granulating machine (Model: CL-8, purchased from Ohkawara Kakohki Co., Ltd.). The slurry is granulated with reaction parameters including a sprayer rotational speed of 16,000 rpm, an inlet temperature of 110° C., an outlet temperature of 80° C., and a feeding speed of 4 kg/hr, and then, the slurry is agglutinated to form an aluminum nitride particle. Finally, the nature of the aluminum nitride particle is determined, and a D50 particle size of 51 μm is given.

### EXAMPLE 6

An aluminum nitride material (1.2 kg) having a particle size of 270 meshes is added in ethanol (1.2 kg), and the aluminum nitride material is wet-milled at 350 rpm for one hour to form aluminum nitride powders having a particle size of 2-3 μm. After the step, polyvinyl butyral (18 g, MW: 110,000-120,000), triethyl phosphate (4.8 g), and yttrium oxide (60 g) are added in the resulted solution to form a slurry having a solid content of 55.5%. Then, the slurry is kept on blending for 22 hr.

The slurry is placed in a granulating machine (Model: CL-8, purchased from Ohkawara Kakohki Co., Ltd.). The slurry is granulated with reaction parameters including a sprayer rotational speed of 10,000 rpm, an inlet temperature of 110° C., an outlet temperature of 80° C., and a feeding speed of 4 kg/hr, and then, the slurry is agglutinated to form an aluminum nitride particle. Finally, the nature of the aluminum nitride particle is determined, and a D50 particle size of 63.6 μm is given.

### EXAMPLE 7

An aluminum nitride material (1.2 kg) having a particle size of 270 meshes is added in ethanol (1.2 kg), and the aluminum nitride material is wet-milled at 350 rpm for one hour to form aluminum nitride powders having a particle size of 2-3 μm. After which, polyvinyl butyral (30 g, MW: 110,000-120,000), triethyl phosphate (4.8 g), and yttrium oxide (60 g) are added in the resulted solution to form a slurry having a solid content of 55.7%. Then, the slurry is kept on blending for 22 hr.

The slurry is placed in a granulating machine (Model: CL-8, purchased from Ohkawara Kakohki Co., Ltd.). The slurry is granulated with reaction parameters including a sprayer rotational speed of 10,000 rpm, an inlet temperature of 110° C., an outlet temperature of 80° C., and a feeding speed of 4 kg/hr, and then, the slurry is agglutinated to form an aluminum nitride particle. Finally, the nature of the aluminum nitride particle is determined, and a D50 particle size of 67.5 μm is given.

As described in the foregoing preferred embodiment, the binding agent, the dispersing agent, and/or the sintering agent are directly mixed with the solution containing the aluminum nitride powders without either drying the solution or adding the aluminum nitride powders into an additional solvent, and therefore the methods disclosed in the embodiments indeed shorten production process and reduce production cost. In another aspect, the product made by the methods disclosed in the embodiments still maintain high quality required by the industry.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for manufacturing an aluminum nitride particle, comprising:
wet-milling an aluminum nitride material to form a solution containing aluminum nitride powders;
mixing a binding agent and a dispersing agent with the solution to gain a slurry; and
granulating the slurry to obtain the aluminum nitride particle.

2. The method as claimed in claim 1, wherein the aluminum nitride material wet-milling step includes mixing the aluminum nitride material with a solvent, and milling the aluminum nitride material.

3. The method as claimed in claim 1, wherein the aluminum nitride powders are in a particle size of 2-12 μm.

4. The method as claimed in claim 2, wherein the aluminum nitride powders are in a particle size of 2-12 μm.

5. The method as claimed in claim 2, wherein the solvent is selected from a group consisting of methyl ethyl ketone, ethyl alcohol, isopropyl alcohol, toluene, diethyl ether, trichloro ethylene, methanol, and combinations thereof.

6. The method as claimed in claim 1, wherein the dispersing agent is selected from a group consisting of ethylene glycol, glycerol, triethyl phosphate, and combinations thereof.

7. The method as claimed in claim 1, wherein the binding agent is selected from a group consisting of vinyl resin, cellulose resin, acrylic resin, and combinations thereof.

8. The method as claimed in claim 1, wherein the slurry has a solid content of 50-60%.

9. A method for manufacturing an aluminum nitride substrate, comprising:
wet-milling an aluminum nitride material to form a solution containing aluminum nitride powders;
blending a binding agent, a dispersing agent, and a sintering agent with the solution to gain a slurry;
granulating the slurry to obtain an aluminum nitride particle; and
sintering the aluminum nitride particle to form the aluminum nitride substrate.

10. The method as claimed in claim 9, wherein the aluminum nitride material wet-milling step includes blending the aluminum nitride material with a solvent, and milling the aluminum nitride material.

11. The method as claimed in claim 9, wherein the aluminum nitride powders are in a particle size of 2-12 μm.

12. The method as claimed in claim 10, wherein the aluminum nitride powders are in a particle size of 2-12 μm.

13. The method as claimed in claim 10, wherein the solvent is selected from a group consisting of methyl ethyl ketone, ethyl alcohol, isopropyl alcohol, toluene, diethyl ether, trichloro ethylene, methanol, and combinations thereof.

14. The method as claimed in claim 9, wherein the dispersing agent is selected from a group consisting of ethylene glycol, glycerol, triethyl phosphate, and combinations thereof.

15. The method as claimed in claim 9, wherein the binding agent is selected from a group consisting of vinyl resin, cellulose resin, acrylic resin, and combinations thereof.

16. The method as claimed in claim 9, wherein the slurry has a solid content of 50-60%.

17. The method as claimed in claim 9, wherein the sintering agent is a rare earth compound.
